(19) United States
(12) Patent Application Publication
(10) Pub. No.: US 2026/0205373 A1
(43) Pub. Date: Jul. 16, 2026

(54) METHODS AND APPARATUSES FOR TRANSMITTING CONTROL SIGNALS TO A PLURALITY OF WIRELESS DEVICES

(71) Applicant: Telefonaktiebolaget LM Ericsson (publ), Stockholm (SE)

(72) Inventors: Abdulrahman ALABBASI, Kista (SE); Konstantinos VANDIKAS, Solna (SE); Ashkan KALANTARI, Malmö (SE)

(73) Assignee: Telefonaktiebolaget LM Ericsson (publ), Stockholm (SE)

(21) Appl. No.: 19/111,301

(22) PCT Filed: Jul. 19, 2023
(86) PCT No.: PCT/EP2023/070065

§ 371 Date: Mar. 12, 2025

(30) Foreign Application Priority Data
Sep. 16, 2022 (GR) 20220100755

(51) Int. Cl. H04L 41/16; H04B 7/0413

(52) U.S. Cl. CPC H04L 41/16; H04B 7/0413

(57) ABSTRACT

Embodiments described herein relate to methods and apparatuses for communicating control signals between a network node and a plurality of wireless devices. A method in a network node comprises determining a plurality of control signals to transmit to a plurality of wireless devices; encoding the plurality of control signals using an encoder module to generate a first latent space representation; and transmitting the first latent space representation to the plurality of wireless devices.

### TECHNICAL FIELD

Embodiments described herein relate to methods and apparatuses for transmitting a plurality of control signals to a plurality of wireless devices. In particular embodiments described herein leverage the fact that control signals may be derived from a limited space.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In a New Radio (NR) system there may be at least two types of signals or messages that are exchanged between the nodes. For example, there may be control plane (CP) signals and user plane (UP) signals.

FIG. 1 illustrates an example of an architecture view of the interfaces between different nodes. User plane signals comprise payload signals which come directly from a data network application, for example, from the wireless devices or from servers of the application (end-point application), using an N9 or an N3 interface. Control plane signals may comprise configuration signals transmitted from a Session Management Function (SMF) and/or an Access and Mobility Management function (AMF) in the core network to other entities in the core network or to Radio Access Network (RAN) entities, using, for example, an N1, N2, N4 or an N11 interface.

It will also be appreciated that control signals may also be transmitted in a WiFi network. In general a control signal may be considered to comprise any signal transmitted to a wireless device that is taken from a limited number of possible signals.

FIG. 2 illustrates the aforementioned interfaces between the core network and the RAN. In particular FIG. 2 refers to entities and interfaces in the 3GPP network. In particular, FIG. 2 illustrates different interfaces between elements in the core network and RAN and the interfaces between the protocol stacks of those elements.

### SUMMARY

One main differentiator between UP and CP signalling is the space or pool from which a message is selected or generated. UP messages typically comprise a payload to be transmitted, so the variance of what the message may comprise is extremely large as it is completely dependent on the wireless device application. However, the pool from which CP signals/messages are selected is limited.

One example of limited space CP signals/messages is the modulation and coding scheme (MCS) selection, which may be sent by a network node (e.g. a gNB) to a wireless device (e.g. a UE) to configure its transmission/reception. Table 1 below illustrates examples of MCS selection messages.

TABLE 1
TS 38.214 v 17.2.0- Table 5.1.3.1-1:
MCS index table 1 for PDSCH

| | | Target code Rate × | |
|---|---|---|---|
| MCS Index | Modulation Order | [1024] | Spectral |
| I_{MCS} | Qₘ | R | efficiency |
| 0 | 2 | 120 | 0.2344 |
| 1 | 2 | 157 | 0.3066 |
| 2 | 2 | 193 | 0.3770 |
| 3 | 2 | 251 | 0.4902 |
| 4 | 2 | 308 | 0.6016 |
| 5 | 2 | 379 | 0.7402 |
| 6 | 2 | 449 | 0.8770 |
| 7 | 2 | 526 | 1.0273 |
| 8 | 2 | 602 | 1.1758 |
| 9 | 2 | 679 | 1.3262 |
| 10 | 4 | 340 | 1.3281 |
| 11 | 4 | 378 | 1.4766 |
| 12 | 4 | 434 | 1.6953 |
| 13 | 4 | 490 | 1.9141 |
| 14 | 4 | 553 | 2.1602 |
| 15 | 4 | 616 | 2.4063 |
| 16 | 4 | 658 | 2.5703 |
| 17 | 6 | 438 | 2.5664 |
| 18 | 6 | 466 | 2.7305 |
| 19 | 6 | 517 | 3.0293 |
| 20 | 6 | 567 | 3.3223 |
| 21 | 6 | 616 | 3.6094 |
| 22 | 6 | 666 | 3.9023 |
| 23 | 6 | 719 | 4.2129 |
| 24 | 6 | 772 | 4.5234 |
| 25 | 6 | 822 | 4.8164 |
| 26 | 6 | 873 | 5.1152 |
| 27 | 6 | 910 | 5.3320 |
| 28 | 6 | 948 | 5.5547 |

| | | |
|---|---|---|
| 29 | 2 | reserved |
| 30 | 4 | reserved |
| 31 | 6 | reserved |

In this example, the limited space/variance of the potential MCS selection messages means that for any wireless device (in any radio condition and with any Key Performance Indicator (KPI) target), the base station may only send 1 out of 32 possible MCS selection messages. The MCS selection message may be transmitted in a Radio Resource Control (RRC) message. For example, in TS 38.331 v 17.1.0 the MCS selection message is transmitted as “PUSCH-Config::=SEQUENCE { . . . }”. In some examples, the MCS selection message may be transmitted as a specific as a Modulation Scheme (Qm) in Downlink Control Information DCI (e.g. as described in TS 38.214 v 17.2.0). Due to flexibility requirements in NR, the base station may be required to transmit MCS messages not only for every user associated with the base station, but also for each serving cell, whether it is a primary or secondary serving cell. Therefore, a base station may be required to transmit a large number of MCS signals.

Another example of CP signalling selected from a limited space is the Channel State Information Reference Signal (CSI-RS) configuration (which may be transmitted from base stations to wireless devices).

The following illustrates examples of CSI-RS configuration messages:

| | |
|---|---|
| CSI-MeasConfig ::= | SEQUENCE { |
| nzp-CSI-RS-ResourceToAddModList | SEQUENCE (SIZE (1..maxNrofNZP- |
| CSI-RS-Resources)) OF NZP-CSI-RS-Resource | OPTIONAL, -- Need N |
| nzp-CSI-RS-ResourceToReleaseList | SEQUENCE (SIZE (1..maxNrofNZP- |
| CSI-RS-Resources)) OF NZP-CSI-RS-ResourceId | OPTIONAL, -- Need N |
| nzp-CSI-RS-ResourceSetToAddModList | SEQUENCE (SIZE (1..maxNrofNZP- |

CSI-RS-ResourceSets)) OF NZP-CSI-RS-ResourceSet

| | |
|---|---|
| | OPTIONAL, -- Need N |
| nzp-CSI-RS-ResourceSetToReleaseList | SEQUENCE (SIZE (1..maxNrofNZP- |

CSI-RS-ResourceSets)) OF NZP-CSI-RS-ResourceSetId

| | |
|---|---|
| | OPTIONAL, -- Need N |
| csi-IM-ResourceToAddModList | SEQUENCE (SIZE (1..maxNrofCSI- |
| IM-Resources)) OF CSI-IM-Resource | OPTIONAL, -- Need N |
| csi-IM-ResourceToReleaseList | SEQUENCE (SIZE (1..maxNrofCSI- |
| IM-Resources)) OF CSI-IM-ResourceId | OPTIONAL, -- Need N |
| csi-IM-ResourceSetToAddModList | SEQUENCE (SIZE (1..maxNrofCSI- |
| IM-ResourceSets)) OF CSI-IM-ResourceSet | OPTIONAL, -- Need N |
| csi-IM-ResourceSetToReleaseList | SEQUENCE (SIZE (1..maxNrofCSI- |
| IM-ResourceSets)) OF CSI-IM-ResourceSetId | OPTIONAL, -- Need N |
| csi-SSB-ResourceSetToAddModList | SEQUENCE (SIZE (1..maxNrofCSI- |
| SSB-ResourceSets)) OF CSI-SSB-ResourceSet | OPTIONAL, -- Need N |
| csi-SSB-ResourceSetToReleaseList | SEQUENCE (SIZE (1..maxNrofCSI- |
| SSB-ResourceSets)) OF CSI-SSB-ResourceSetId | OPTIONAL, -- Need N |
| csi-ResourceConfigToAddModList | SEQUENCE (SIZE (1..maxNrofCSI- |

ResourceConfigurations)) OF CSI-ResourceConfig

| | |
|---|---|
| | OPTIONAL, -- Need N |
| csi-ResourceConfigToReleaseList | SEQUENCE (SIZE (1..maxNrofCSI- |

ResourceConfigurations)) OF CSI-ResourceConfigId

| | |
|---|---|
| | OPTIONAL, -- Need N |
| csi-ReportConfigToAddModList | SEQUENCE (SIZE (1..maxNrofCSI- |
| ReportConfigurations)) OF CSI-ReportConfig | OPTIONAL, -- Need N |
| csi-ReportConfigToReleaseList | SEQUENCE (SIZE (1..maxNrofCSI- |

ReportConfigurations)) OF CSI-ReportConfigId

| | |
|---|---|
| | OPTIONAL, -- Need N |
| reportTriggerSize | INTEGER |
| (0..6) | OPTI |

ONAL, -- Need M

| | |
|---|---|
| aperiodicTriggerStateList | SetupRelease { CSI- |
| AperiodicTriggerStateList } | OPTIONAL, -- |

Need M

| | |
|---|---|
| semiPersistentOnPUSCH-TriggerStateList | SetupRelease { CSI- |
| SemiPersistentOnPUSCH-TriggerStateList } | OPTIONAL, -- Need M |

```
  ...,
  [[
```

| | |
|---|---|
| reportTriggerSizeDCI-0-2-r16 | INTEGER |
| (0..6) | OPTI |

```
ONAL -- Need R
  ]],
  [[
```

| | |
|---|---|
| sCellActivationRS-ConfigToAddModList-r17 | SEQUENCE (SIZE |

(1..maxNrofSCellActRS-r17)) OF SCellActivationRS-Config-
r17 OPTIONAL, -- Need N

| | |
|---|---|
| sCellActivationRS-ConfigToReleaseList-r17 | SEQUENCE (SIZE |

(1..maxNrofSCellActRS-r17)) OF SCellActivationRS-ConfigId-r17
OPTIONAL -- Need N
]]
}

Similarly to the transmission of the CSI-RS configurations (e.g. a CSI-MeasConfig message), the associated reporting configurations (e.g. CSI-ReportConfig information elements) transmitted from wireless devices to base stations are also selected from a limited space. For example, the following illustrates examples of reporting configurations:

| | |
|---|---|
| CSI-ReportConfig ::= | SEQUENCE { |
| reportConfigId | CSI-ReportConfigId, |
| carrier | ServCellIndex |

OPTIONAL, -- Need S

| | |
|---|---|
| resourcesForChannelMeasurement | CSI-ResourceConfigId, |
| csi-IM-ResourcesForInterference | CSI- |
| ResourceConfigId | OPTIONAL, -- Need R |
| nzp-CSI-RS-ResourcesForInterference | CSI- |
| ResourceConfigId | OPTIONAL, -- Need R |
| reportConfigType | CHOICE { |
| periodic | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semiPersistentOnPUCCH | SEQUENCE { |
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | |
|---|---|
| semi-PersistentOnPUSCH | SEQUENCE { |
| reportSlotConfig | ENUMERATED {sl5, |

sl10, sl20, sl40, sl80, sl160, sl320},

| | |
|---|---|
| reportSlotOffsetList | SEQUENCE (SIZE (1.. |

maxNrofUL-Allocations)) OF INTEGER(0..32),

| | |
|---|---|
| p0alpha | P0-PUSCH- |

AlphaSetId
},

| | |
|---|---|
| aperiodic | SEQUENCE { |
| reportSlotOffsetList | SEQUENCE (SIZE |

```
(1..maxNrofUL-Allocations)) OF INTEGER(0..32)
    }
  },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, |
| n4} | OPTIONAL -- Need S |

},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { |
| widebandCQI, subbandCQI } | OPTIONAL, -- Need |

R

| | |
|---|---|
| pmi-FormatIndicator | ENUMERATED { |
| widebandPMI, subbandPMI } | OPTIONAL, -- Need |

R

| | |
|---|---|
| csi-ReportingBand | CHOICE { |
| subbands3 | BIT |

STRING(SIZE(3)),

| | |
|---|---|
| subbands4 | BIT |

STRING(SIZE(4)),

| | |
|---|---|
| subbands5 | BIT |

STRING(SIZE(5)),

| | |
|---|---|
| subbands6 | BIT |

STRING(SIZE(6)),

| | |
|---|---|
| subbands7 | BIT |

STRING(SIZE(7)),

| | |
|---|---|
| subbands8 | BIT |

STRING(SIZE(8)),

| | |
|---|---|
| subbands9 | BIT |

STRING(SIZE(9)),

| | |
|---|---|
| subbands10 | BIT |

STRING(SIZE(10)),

| | |
|---|---|
| subbands11 | BIT |

STRING(SIZE(11)),

| | |
|---|---|
| subbands12 | BIT |

STRING(SIZE(12)),

| | |
|---|---|
| subbands13 | BIT |

STRING(SIZE(13)),

| | |
|---|---|
| subbands14 | BIT |

STRING(SIZE(14)),

| | |
|---|---|
| subbands15 | BIT |

STRING(SIZE(15)),

| | |
|---|---|
| subbands16 | BIT |

STRING(SIZE(16)),

| | |
|---|---|
| subbands17 | BIT |

STRING(SIZE(17)),

| | |
|---|---|
| subbands18 | BIT |

STRING(SIZE(18)),
...,

| | |
|---|---|
| subbands19-v1530 | BIT |

```
STRING(SIZE(19))
    } OPTIONAL -- Need S
  }
```

| | |
|---|---|
| | OPTIONAL, -- Need R |
| timeRestrictionForChannelMeasurements | ENUMERATED |

{configured, notConfigured},

| | |
|---|---|
| timeRestrictionForInterferenceMeasurements | ENUMERATED |

{configured, notConfigured},

| | |
|---|---|
| codebookConfig | CodebookConfig |
| | OPTIONAL, -- Need R |
| dummy | ENUMERATED {n1, |
| n2} | OPTIONAL, -- Need R |
| groupBasedBeamReporting | CHOICE { |
| enabled | NULL, |
| disabled | SEQUENCE { |
| nrofReportedRS | ENUMERATED {n1, |
| n2, n3, n4} | OPTIONAL -- Need S |

```
    }
  },
```

| | |
|---|---|
| cqi-Table | ENUMERATED {table1, table2, table3, |
| table4-r17} | OPTIONAL, -- Need R |
| subbandSize | ENUMERATED {value1, value2}, |
| non-PMI-PortIndication | SEQUENCE (SIZE (1..maxNrofNZP-CSI-RS- |

```
ResourcesPerConfig)) OF PortIndexFor8Ranks OPTIONAL, -- Need R
  ...,
  [[
```

| | |
|---|---|
| semiPersistentOnPUSCH-v1530 | SEQUENCE { |
| reportSlotConfig-v1530 | ENUMERATED {sl4, sl8, |

sl16}
}

OPTIONAL -- Need R

]],

This CSI-MeasConfig message and CSI-ReportConfig IEs are control messages that are also required to be transmitted to a large number of wireless devices (either simultaneously or occasionally).

Another CP message that may be considered to be selected from a limited space is the PHY signal DCI (Downlink Control Information) format 1_0 (DCI_1_0) scrambled by C-RNTI (Cell Radio Network Temporary Identifier), an example of which is illustrated in Table 2 below. The DCI_1_0 comprises, for example, frequency and time domain allocation bits, MCS allocation bits, and HARQ process number, etc. The average number of bits sent via DCI_1_0 is about 33 bits per allocation per wireless device.

If, for example, there are 100 wireless devices in a cell, the number of control bits per allocation event is about 3.3 kbits, which is an extremely large overhead.

TABLE 2
DCI format 1_0 with CRC scrambled by C-RNTI, TS 38.212 v 17.2.0.
<DCI format 1_0 with CRC scrambled by C-RNTI>

| Field (Item) | Bits | Reference |
|---|---|---|
| Identifier for DCI formats | 1 | Always set to 1, meaning this is for |
| | | DL |
| Frequency domain resource | Variable | Variable with DL BWP N_RB |
| assignment | | ┌log₂(N_{RB}^{DL, BWP}(N_{RB}^{DL, BWP} + 1)/2)┐ |
| Time domain resource assignment | 4 | Carries the row index of the items |
| | | in pdsch_allocationList in RRC |
| VRB-to-PRB mapping | 1 | According to 38.212 Table |
| | | 7.3.1.1.2-33 |
| | | 0: Non-Interleaved |
| | | 1: Inverleaved |
| Modulation and coding scheme | 5 | 38.214 - Table 5.1.3.1-1: MCS index table 1 |
| | | for PDSCH |
| | | 38.214 - Table 5.1.3.1-2: MCS index table 2 |
| | | for PDSCH |
| New data indicator | 1 | |
| Redundancy version | 2 | |
| HARQ process number | 4 | |
| Downlink assignment index | 2 | |
| TPC command for scheduled PUCCH | 2 | |
| PUCCH resource indicator | 3 | See here, here |
| PDSCH-to-HARQ_feedback timing | 3 | maps to k1 = {1, 2, 3, 4, 5, 6, 7, 8} - |
| indicator | | NOTE 2 |

It will therefore be appreciated that there are many messages that span limited spaces that are sent (simultaneously or opportunistically) to all wireless devices. Due to the generality of the purpose of control messages, their inherited design may be relatively-large (e.g., 3.3 kbits for 100 wireless devices for a single DCI scheduling occasion) in relation to their role of being a control signal. Control signals may also be transmitted relatively frequently. Therefore, when these signals are transmitted in a uni-cast fashion, for example transmitted to each wireless device individually, this may cause a large network overhead/footprint, high energy consumption, and a reduction of actual payload-throughput.

According to some embodiments there is provided a method of training an autoencoder for use in transmitting control signals between a network node and a plurality of wireless devices, wherein the autoencoder comprises: an encoder module, and a respective plurality of decoder modules associated with the plurality of wireless devices. The method comprises encoding a first set of training data using the encoder module to generate a first latent space representation, wherein the first set of training data comprises control signals associated with the plurality of wireless devices; using the plurality of decoder modules to decode the first latent space representation to generate a respective plurality of reconstructed control signals; and updating the plurality of decoder modules based on the plurality of reconstructed control signals.

According to some embodiments there is provided a method, in a network node, of transmitting control signals to a plurality of wireless devices. The method comprises determining a plurality of control signals to transmit to a plurality of wireless devices; encoding the plurality of control signals using an encoder module to generate a first latent space representation; and transmitting the first latent space representation to the plurality of wireless devices.

According to some embodiments the is provided a method, in a wireless device, of receiving control signals from a network node. The method comprises receiving a first latent space representation, wherein the first latent space representation comprises information derived from a plurality of control signals; and decoding the first latent space representation using a decoder module to determine a first control signal.

According to some embodiments there is provided a training apparatus for training an autoencoder for use in transmitting control signals between a network node and a plurality of wireless devices, wherein the autoencoder comprises: an encoder module, and a respective plurality of decoder modules associated with the plurality of wireless devices. The training apparatus comprising processing circuitry configured to cause the training apparatus to: encode a first set of training data using the encoder module to generate a first latent space representation, wherein the first set of training data comprises control signals associated with the plurality of wireless devices; use the plurality of decoder modules to decode the first latent space representation to generate a respective plurality of reconstructed control signals; and update the plurality of decoder modules based on the plurality of reconstructed control signals.

According to some embodiments there is provided a network node for transmitting control signals to a plurality of wireless devices. The network node comprises processing circuitry configured to cause the network node to: determine a plurality of control signals to transmit to a plurality of wireless devices; encode the plurality of control signals using an encoder module to generate a first latent space representation; and transmit the first latent space representation to the plurality of wireless devices.

According to some embodiments there is provided a wireless device for receiving control signals from a network node. The wireless device comprising processing circuitry configured to cause the wireless device to: receive a first latent space representation, wherein the first latent space representation comprises information derived from a plurality of control signals; and decode the first latent space representation using a decoder module to determine a first control signal.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates an example of an architecture view of the interfaces between different nodes;

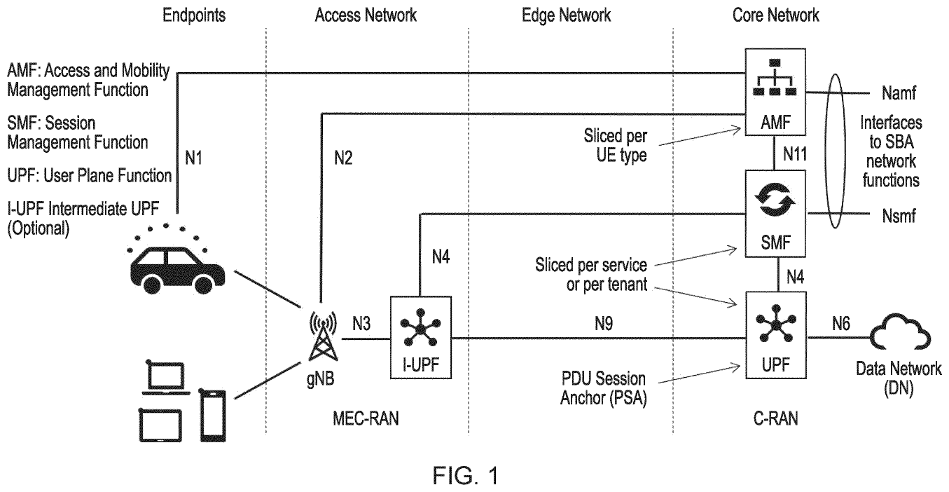

FIG. 2 illustrates the aforementioned interfaces between the core network and the RAN;

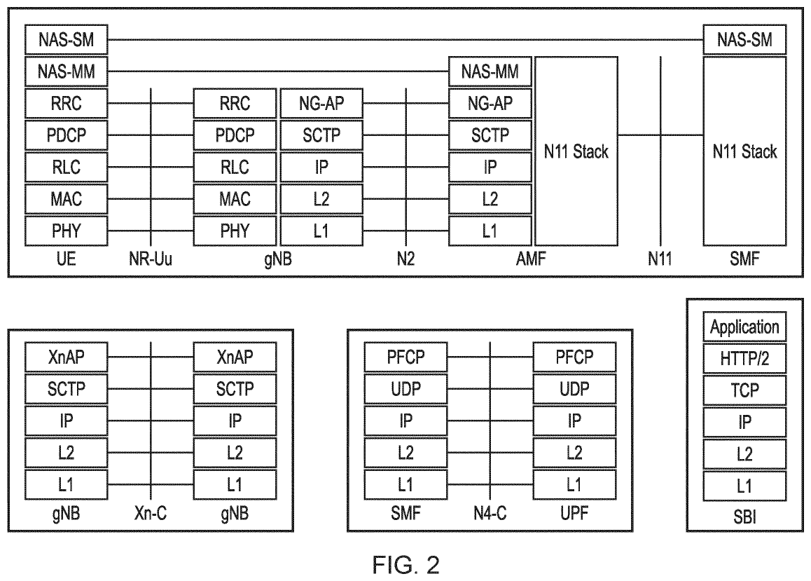

FIG. 3 illustrates a system for transmitting control signals from a network node to a plurality of wireless devices;

FIG. 4 illustrates a method, in a network node, of transmitting control signals to a plurality of wireless devices;

FIG. 5 illustrates a method for receiving control signals from a network node;

FIG. 6 illustrates an example implementation of FIGS. 4 and 5;

FIG. 7 illustrates a method of training an autoencoder for use in transmitting control signals between a network node and a plurality of wireless devices;

FIG. 8 illustrates an example implementation of FIGS. 4, 5 and 7;

FIG. 9 illustrates an example of a cyclic redundancy check (CRC);

FIG. 10 illustrates a training apparatus comprising processing circuitry;

FIG. 11 is a block diagram illustrating a training apparatus according to some embodiments;

FIG. 12 illustrates a network node comprising processing circuitry;

FIG. 13 is a block diagram illustrating a network node according to some embodiments;

FIG. 14 illustrates a wireless device comprising processing circuitry;

FIG. 15 is a block diagram illustrating a wireless device according to some embodiments.

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Embodiments described herein relate to an efficient broadcasting mechanism for control signals for a group of wireless devices. The methods described herein utilize a machine learning process to generate a latent space representation to broadcast the control signals. After encoding the control signals at a network node, the resulting latent space representation is transmitted to group of wireless devices, where each wireless device decodes the latent space representation to receive its specific control signal.

Embodiments described herein also relate to the training of an autoencoder for use in encoding and/or decoding such a latent space representation. In some examples, a cyclic redundancy check (CRC) error check detection is used to verify that no error occurred at the channel transmission and/or at the output of a decoder module.

In some embodiments a clustering process may be used to cluster the wireless devices such that encoding and decoding may be performed for wireless devices that have close latent spaces.

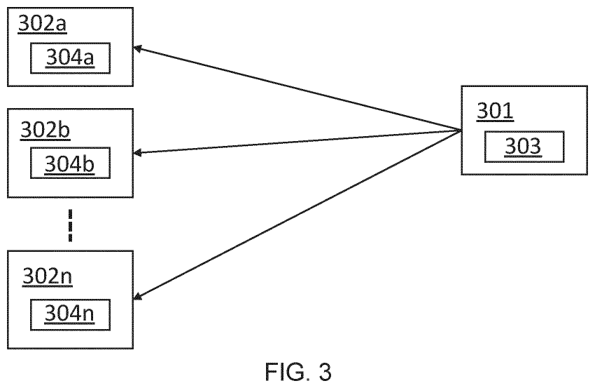

FIG. 3 illustrates a system 300 for transmitting control signals from a network node 301 to a plurality of wireless devices 302a to 302n.

The network node 301 may be configured to broadcast a latent space representation comprising control signal information to the plurality of wireless devices 302a to 302n. The network node 301 comprises an encoder module 303. Each wireless device 302a to 302n comprises a decoder module 304a to 304n.

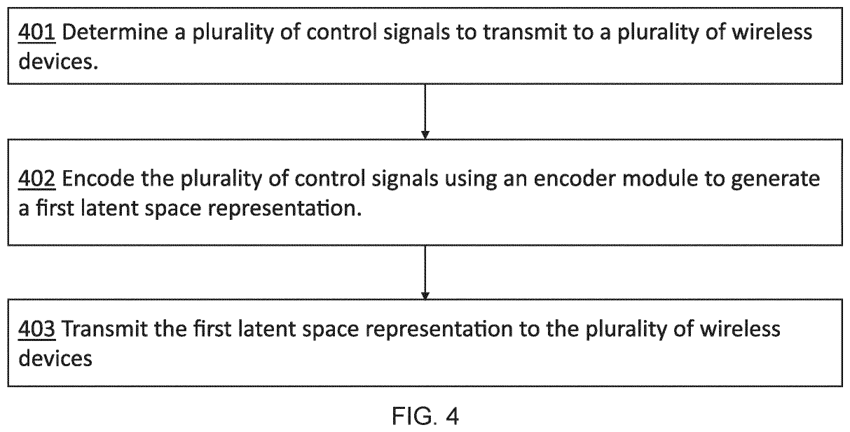

FIG. 4 illustrates a method, in a network node, of transmitting control signals to a plurality of wireless devices.

The method 400 may be performed by a network node, which may comprise a physical or virtual node, and may be implemented in a computing device or server apparatus and/or in a virtualized environment, for example in a cloud, edge cloud or fog deployment. The network node may comprise a base station for example an eNB or a gNB. It will be appreciated that the network node may comprise a distributed network node. The method of FIG. 400 may be performed by one or many units in a distributed network node.

It will be appreciated that the method of FIG. 4 may be performed by the network node 301 illustrated in FIG. 3.

In step 401 the network node determines a plurality of control signals to transmit to a plurality of wireless devices.

In step 402 the network node encodes the plurality of control signals using an encoder module to generate a first latent space representation.

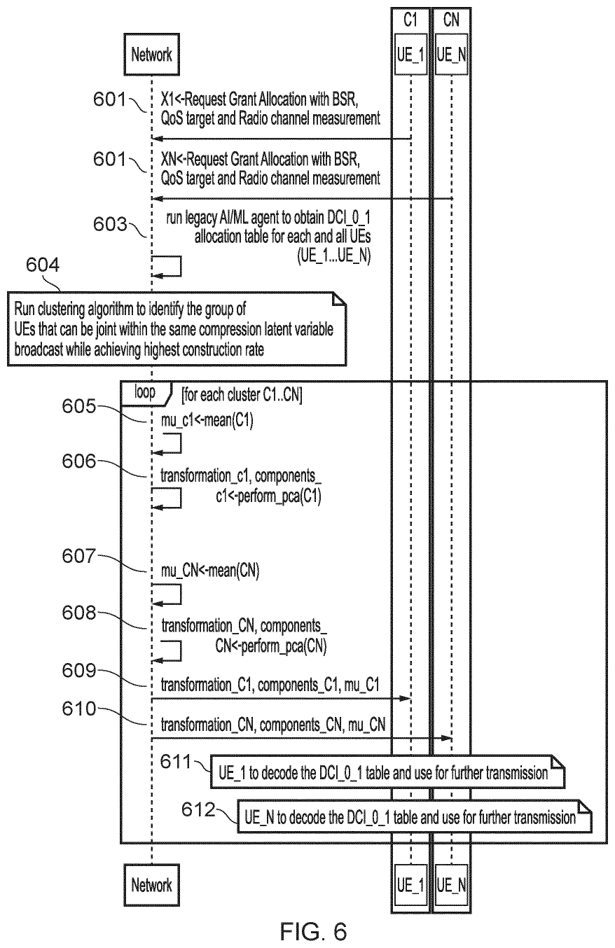

In some examples step 402 may comprise utilizing Principal Component Analysis, PCA. to determine one or more principal components, wherein the first latent space representation comprises the determined one or more principal components. The use of PCA for performing step 402 will be described in more detail with reference to FIG. 6.

The first latent space representation may further comprise a mean value of the features in the plurality of control signals column wise. The first latent space representation may further comprise a transformation.

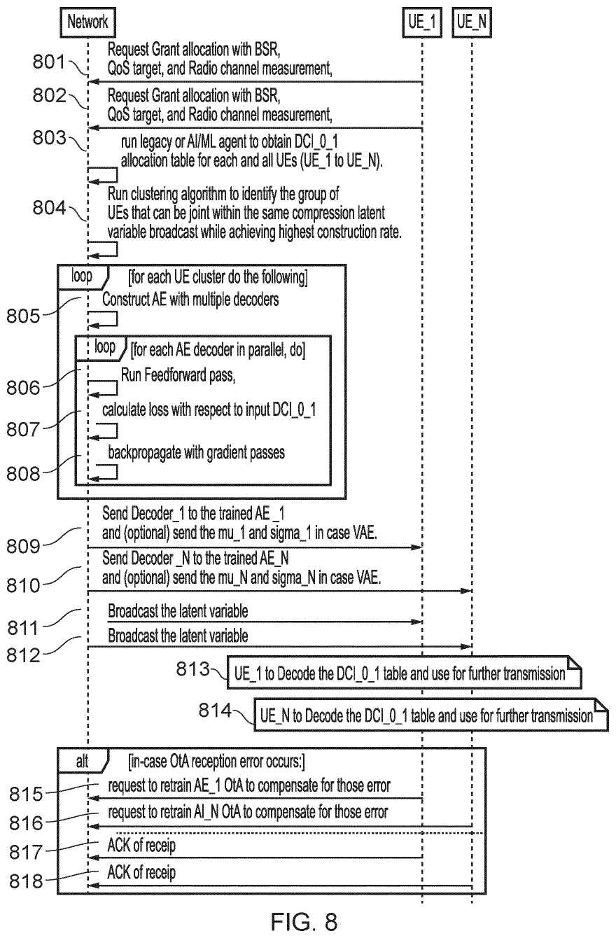

In other examples, step 402 may comprise utilizing an encoder module neural network comprised in an autoencoder to perform the encoding. The use of an autoencoder to perform step 402 will be described in more detail with reference to FIG. 8.

In step 403 the network node transmits the first latent space representation to the plurality of wireless devices. Step 403 may comprise multicasting or broadcasting the first latent space representation to the plurality of wireless devices.

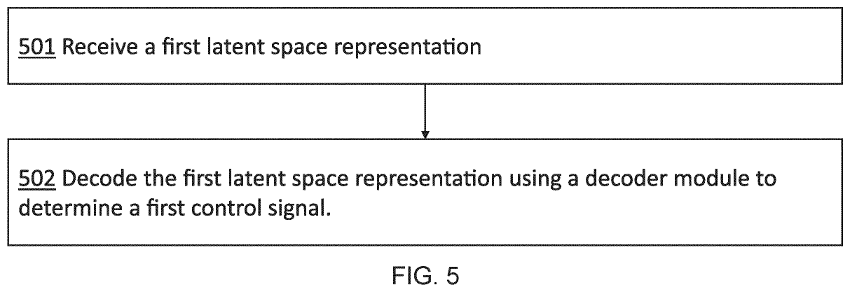

FIG. 5 illustrates a method for receiving control signals from a network node. The method of FIG. 5 may be performed by a wireless device, such as wireless devices 302a to 302n as illustrated in FIG. 3.

In step 501, the wireless device receives a first latent space representation. Step 501 comprises receiving a multicast or broadcast of the first latent space representation.

In step 502, the wireless device decodes the first latent space representation using a decoder module to determine a first control signal.

As described above the first latent space representation may, for example, be generated using PCA or using a neural network of an encoder module of an autoencoder.

The first latent space representation may therefore comprise one or more principal components, P. The first latent space representation may further comprise a mean value, mu, and/or a transformation, T. Step 502 may then comprise calculating a dot product of the transformation and a transpose of the principal components; and adding the mean value.

For example, the first control signal may be calculated as:

$${P}^{T} \cdot T + mu$$

In some examples, step 502 comprises utilizing a decoder module neural network comprised in an autoencoder to perform the decoding.

FIG. 6 illustrates an example implementation of FIGS. 4 and 5.

In FIG. 6 the plurality of control signals is encoded using PCA.

In step 601 a first wireless device 302a transmits to the network node 301 a request for control signal information. In this example, the request comprises a request for grant allocation with Buffer Status Report (BSR), Quality of Service (QoS) target and radio channel measurement.

In step 602, a second wireless device 302b transmits to the network node 301 a request for control signal information. In this example, the request comprises a request for grant allocation with BSR, QoS target and radio channel measurement.

It will be appreciated that the network node 301 may receive requests such as those illustrated in steps 601 and 602 from an initial group of wireless devices.

In step 603 the network node 301 determines a plurality of control signals to transmit to the initial group of wireless devices, including the first wireless device and the second wireless device. For example, step 603 may comprise the network node running a legacy method (e.g. an AI/ML software agent) to obtain control signal allocations for each of the initial group of wireless devices. Step 603 comprises an example implementation of step 401 of FIG. 4.

In step 604, the network node clusters the initial group of wireless devices based on one or more criteria. The one or more criteria may comprise one or more of: similar Quality of Service, QoS, targets; similar radio channels; wireless devices associated with the same Multiple Input Multiple Output (MIMO) layers.

For example, the wireless devices in a cluster may have the same 5QI index. The wireless devices in a cluster may have the same BSR index. The wireless devices in a cluster may have less than a predetermined Kullback-Leibler (KL) distance between the CSI distribution of those devices. The wireless devices in a cluster may have less than a predetermined value for the aggregated sum of eigen channels that represent each MIMO layer.

The wireless devices in a cluster may have the same or similar values for any specific Radio Access Network (RAN) related functionality, that is required to provide a group of control messages from the network node which share similar dimensions of latent space at a bottleneck layer (or e.g., sharing similar sample space). For example, wireless devices having the same Multiple Input Multiple Output (MIMO) layers, would receive control signals spanning the same pool of control messages addressing those specific MIMO layers. Hence, these wireless devices may be clustered together. However, joining wireless devices with Massive-MIMO into the same cluster as those with only MIMO may cause difficulties in reconstruction of the control messages, for example, the latent space may not have the same dimension.

It will be appreciated that a distance in criteria used for clustering wireless devices may be a distance that enables a higher reconstruction accuracy. In other words, a distance in criteria may be smaller between those wireless devices that have MCS (or DCI) that results in maximum accuracy (or minimum loss) when training the encoder module with the plurality of decoder modules.

In the example of FIG. 6, the first wireless device 302a belongs to a first cluster C1 and the second wireless device 302b belongs to a second cluster CN.

Steps 605 to 606 comprise an example of step 402 Of FIG. 4. Steps 605 to 606 illustrate an example of how PCA may be used to encode the plurality of control signals.

In step 605, the network node determines a mean value, mu_C1, of every feature column wise for all inputs from wireless devices in the first cluster.

In step 606 the network node performs principal components analysis on each the plurality of inputs received from wireless devices in the first cluster and generates a transformation (also known as scores), transformation_C1, and the principal components, components_C1.

Steps 607 to 608 comprise an example of step 402 Of FIG. 4. Steps 607 to 608 illustrate an example of how PCA may be used to encode the plurality of control signals.

In step 607, the network node determines a mean value, mu_CN, of every feature column wise for all inputs from wireless devices in the second cluster, CN.

In step 608 the network node performs principal components analysis on each the plurality of inputs received from wireless devices in the second cluster and generates a transformation (also known as scores), transformation_CN, and the principal components, components_CN.

In step 609, the network node transmits a first latent space representation to the wireless devices in the first cluster. In this example, the first latent space representation comprises the mean value, mu_C1, determined in step 605. In this example, the first latent space representation further comprises the transformation_C1 and the principal component, components_C1 determined in step 606.

In step 610, the network node transmits a second latent space representation to the wireless devices in the second cluster. In this example, the second latent space representation comprises the mean value, mu_CN, determined in step 607. In this example, the second latent space representation further comprises the transformation_CN and the principal component, components_CN determined in step 608.

Steps 609 and 610 comprise example implementations of step 403 of FIG. 4.

In steps 611 and 612 the first wireless device 302a and the second wireless device 302b then may utilise the received latent space representations to decode their respective control signals (for example as described above with reference to FIG. 5).

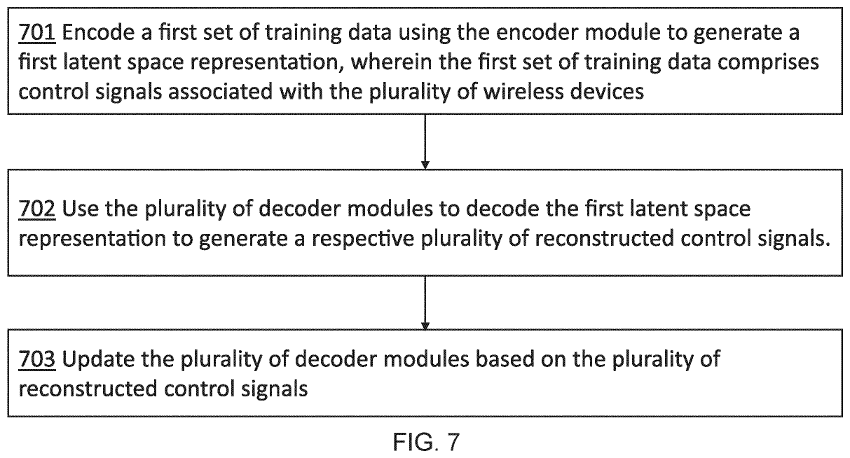

In some examples, as described above, the step 402 and step 502 are performed by an autoencoder. Such an autoencoder may be trained as described below with reference to FIG. 7.

FIG. 7 illustrates a method of training an autoencoder for use in transmitting control signals between a network node and a plurality of wireless devices. The autoencoder comprises: an encoder module, and a respective plurality of decoder modules associated with the plurality of wireless devices. It will be appreciated that the control signals may be selected from a limited space, for example as described in the background section herein.

The method 700 may be performed by a network node, which may comprise a physical or virtual node, and may be implemented in a computing device or server apparatus and/or in a virtualized environment, for example in a cloud, edge cloud or fog deployment. The network node may comprise a base station for example an eNB or a gNB. It will be appreciated that the network node may comprise a distributed network node. The method of FIG. 700 may be performed by one or many units in a distributed network node.

In step 701, the method comprises encoding a first set of training data using the encoder module to generate a first latent space representation, wherein the first set of training data comprises control signals associated with the plurality of wireless devices. It will be appreciated that as the training may be performed at the network node in its entirety, the first set of training data comprising control signals may not actually be transmitted to the wireless devices. The aim of the method of FIG. 7 is to train the autoencoder such that the output of each decoder module is equal to the control signal associated with relevant wireless device in the first set of training data. The method of FIG. 7 may aim to train the autoencoder such that the accuracy of the reconstruction of as close as possible to 100%.

In some examples, S_Ltn is the minimum size of the latent space representation that enables complete reconstruction of the control signals at the outputs of the decoder modules.

In step 702, the method comprises using the plurality of decoder modules to decode the first latent space representation to generate a respective plurality of reconstructed control signals.

In step 703 the method comprises updating the plurality of decoder modules based on the plurality of reconstructed control signals. For example, the method may comprise calculating a reconstruction loss and utilizing that reconstruction loss to update the plurality of decoder modules.

In some examples, the function for determining the reconstruction loss for all the decoder modules may be the same. For example, step 703 may comprise, for a first decoder module in the plurality of decoder modules, wherein the first decoder module is associated with a first wireless device: determining a first loss function based on the output of the first decoder module and a control signal in the first set of training data associated with the first wireless device. The first loss function may comprise a minimum square error between a reconstructed control signal, at the first decoder module, and the actual corresponding control signal that was encoded for the first decoder module.

In some examples, the reconstruction loss function comprises a generalized loss function for each of the decoder modules (e.g. for N decoder modules, each pair of a decoder module at a wireless device (UEᵤ, 1≤u≤N) and the network node) that reflects specificality of certain group of wireless devices. For example, step 703 may comprise determining a generalised loss function based on the first loss function (MSE_{UE}_{₁}(Tk)) at a current time (Tk) and previous loss functions (MSE_{UE}_{ᵤ}(Tₖ₋₁)) calculated for the plurality of decoder modules at a previous time; and updating the first decoder module using the generalised loss function.

For example, the generalised loss function (LOSS_{UE}_{₁}(Tₖ)) may comprise a MSE of that specific decoder module at a time Tₖ plus an error off all wireless devices at a previous time step. This consideration may enable the optimization of each decoder module given the common encoder, while considering the error of other decoder modules in the previous time-step. The generalised loss function may be expressed in the following equation.

$${Loss}_{{UE}_{1}} ( {T}_{k} ) = {MSE}_{{UE}_{1}} ( {T}_{k} ) + \frac{1}{N} {\sum }_{u = {UE}_{1}}^{{UE}_{N}} {MSE}_{{UE}_{u}} ( {T}_{k - 1} ) .$$

FIG. 8 illustrates an example implementation of FIGS. 4, 5 and 7. In this example, steps 402 of FIG. 4 and 502 of FIG. 5 are performed by an autoencoder.

In step 801 a first wireless device 302a transmits to the network node 301 a request for control signal information. In this example, the request comprises a request for grant allocation with BSR, QoS target and radio channel measurement.

In step 802, a second wireless device 302b transmits to the network node 301 a request for control signal information. In this example, the request comprises a request for grant allocation with BSR, QoS target and radio channel measurement.

It will be appreciated that the network node 301 may receive requests such as those illustrated in steps 801 and 802 from an initial group of wireless devices.

In step 803 the network node 301 determines a plurality of control signals to transmit to the plurality of wireless devices (e.g. the first wireless device and the second wireless device). For example, step 803 may comprise the network node running a legacy method (e.g. an AI/ML software agent) to obtain control signal allocations for each of the initial group of wireless devices comprising the first wireless device 302a and the second wireless device 302b. Step 803 comprises an example implementation of step 401 of FIG. 4.

The plurality of control signals may comprise one or more of: Modulation and Coding Scheme, MCS, selection signals, Channel state information-Reference Signal, CSI-RS, configuration signals, Downlink Control Indication, DCI, format signals and Configured Grant Configuration signals.

In step 804 the network node clusters the initial group of wireless devices based on one or more criteria. The one or more criteria may comprise one or more of: similar Quality of Service, QoS, targets; similar radio channels; wireless devices associated with the same Multiple Input Multiple Output (MIMO) layers.

For example, the wireless devices in a cluster may have the same 5QI index. The wireless devices in a cluster may have the same BSR index. The wireless devices in a cluster may have less than a predetermined KL distance between the CSI distribution of those devices. The wireless devices in a cluster may have less than a predetermined value for the aggregated sum of eigen channels that represent each MIMO layer.

The wireless devices in a cluster may have the same or similar values for any specific RAN related functionality, that is required to provide a group of control message from the network node which share similar dimension of latent space at a bottleneck layer (or e.g., sharing similar sample space). For example, wireless devices having the same MIMO layers, would receive control signals spanning the same pool of control messages addressing those specific MIMO layers. Hence, these wireless devices may be clustered together. However, joining wireless devices with Massive-MIMO into the same cluster as those with only MIMO may cause difficulties in reconstruction of the control messages, i.e., the latent space may not have the same dimension.

In this example, the first wireless device 302a and the second wireless device 302b are considered to be part of the same cluster, e.g. C1.

Steps 805 to 808 illustrate an example of training an autoencoder. Steps 805 to 808 illustrate an example implementation of the method of FIG. 7. Steps 805 to 808 may be performed for each cluster.

In step 805, the network node constructs an autoencoder comprising a plurality of decoder modules and a single encoder module. It will be appreciated that the network node may construct an autoencoder with a decoder module for each wireless device in the cluster.

Steps 806 to 808 are performed for each decoder module of the autoencoder, in parallel.

In step 806, the network node runs a feedforward pass through the autoencoder.

For example, by performing step 806 for each decoder module, the network node may encode a first set of training data using the encoder module to generate a first latent space representation, wherein the first set of training data comprises control signals associated with the plurality of wireless devices.

The network node may then use the plurality of decoder modules to decode the first latent space representation to generate a respective plurality of reconstructed control signals.

Step 806 comprises an example implementation of steps 701 and 702.

In step 807, the network node determines a loss function. The loss function may be determined as described above with reference to FIG. 7.

In step 808, the network node performed decoder backpropagation. For example, the network node may update the decoder modules based on the loss function determined in step 807.

In some examples, step 808 comprises updating the plurality of decoder modules in turn.

In some examples, the network node also performs encoder backpropagation. For example, step 808 may comprise, during updating of a first decoder module, updating first layers of the encoder module, wherein the first layers of the encoder module are related to the first decoder module.

For example, if the autoencoder comprises n decoder modules D-1 to D-n, the updating of the decoder modules may be performed as follows:

The decoder module D-1 may be updated given the latent space representation and the encoder module. To do this, the network node may backpropagate on D-1. The network node may also back-propagate on some layers of the encoder module. For example, the layers related to the decoder module D-1 may be updated whilst the layers related to D2-D-n are frozen.

The decoder modules D-2 to D-n may then be updated in turn in a similar manner.

In some examples, the encoder module is frozen whilst the decoder modules are updated. For example, step 808 may comprise freezing the encoder module during updating of the plurality of decoder modules. In these examples, the decoder modules D-1 to D-n may be back-propagated in turn.

Steps 807 and 808 comprise an example implementation of step 703 of FIG. 7.

In some examples, after initial training of an autoencoder for a cluster further clustering may be performed.

For example, the method may comprise clustering the plurality of wireless devices (e.g. those in the first cluster) to determine subgroups of wireless devices. k-means. dbscan, and or gmm may be used to cluster the wireless devices.

For each subgroup of wireless devices, the method may then further comprise training a new encoder module and retraining the decoder modules associated with the subgroup of wireless devices. In other words, a new autoencoder comprising a new encoder module and a plurality of decoder modules may be trained for the subgroup of wireless devices.

In some examples, it may be assumed that the latent spaces from derived from providing multiple inputs through the encoder module 1 to m (e.g., L1→Lm) are projected into the “same or close” dimension. The term “same or close” may be measured via KL divergence among the latent space dimensions or distributions.

The clustering of wireless devices may then comprise clustering together those wireless devices, say from 1 to x within the same cluster that receive the latent spaces L1-to-Lm

The clustering of the plurality of wireless devices may comprise for each decoder module, determining which of a plurality of latent space channels affect the output of the decoder module. The clustering of the plurality of wireless devices may then comprise grouping wireless devices associated with decoder modules that are affected by the same latent space channels. In some examples, the plurality of wireless devices may be grouped based on whether particular latent channels affect the output of the associated decoder modules at all. In some examples, the plurality of wireless devices may be grouped based on which latent channels represented the most important features, in other words, which latent channels have the greatest affect on the output of the decoder modules.

The network node may therefore run a feature importance process to determine which features are the most important for each decoder module. Feature importance may be determined either via XGBoost, SHAP/LIME techniques. These techniques aim at identifying how each feature impacts the target variable of a model, for example by omitting an input feature they measure how much the target variable changed. The bigger the change, the more important the input feature.

For example, if the latent space L1-Lm is used as an input and each UE-dec as output, then put all UEs that share the first 1-m latent as the most important features for them.

After the training steps 805 to 808, and optionally after retraining with further clustering as described above, the method of FIG. 8 will have produced trained decoder modules corresponding to each wireless device.

In steps 809 and 810, the network node then transmits information to each of the plurality of wireless devices to enable each wireless device to implement its corresponding decoder modules.

In step 809, the network node transmits information to the first wireless device 302a for implementation of the respective decoder module, Decoder_1.

In step 810, the network node transmits information to the second wireless device 302b for implementation of the respective decoder module, Decoder_2.

In some examples, the autoencoder may comprise a variational autoencoder. In these examples, the values of a mean value and a variance may also be transmitted to the wireless devices.

Steps 811 to 818 illustrate an example implementation of FIGS. 4 and 5.

In steps 811 and 812, the network node encodes the control signals determined in step 803 using the trained encoder module and broadcasts the resulting latent space representation to the plurality of wireless devices (e.g. comprising the first wireless device 302a and the second wireless device 302b). For example, the network node may apply the DCI_0_1 (or selected MCS indices) for N wireless devices as an input to the trained encoder module. The network node may then broadcast the latent space representation to the decoder modules at the N wireless devices. Steps 811 and 812 comprise a example implementation of step 403 of FIG. 4 or step 501 of FIG. 5.

In step 813, the first wireless device 302a inputs the received latent space representation into its decoder module to determine a first control signal.

In step 814, the second wireless device 302b inputs the received latent space representation into its decoder module to determine a second control signal.

Steps 813 and 814 comprise example implementations of step 502 of FIG. 5.

In some examples, the autoencoder may be trained such that it receives a further input as well as the plurality of control signals. For example, the encoder module may be configured to receive one or more of: a target Quality of Service of the plurality of wireless devices; and a radio channel type of input (e.g. Channel State Information (CSI)/Channel Quality Indicator (CQI)/Reference Signal Received Power (RSRP)/Reference Signal Received Quality (RSRQ)/Signal to Interference plus Noise Ratio (SINR)), MIMO layers used by the wireless devices, BSR, an indication of whether a wireless device has a duplication of legs (e.g. two parallel connections to a base station).

In some examples, the step of using the plurality of decoder modules to decode the first latent space representation comprises: inputting, into the plurality of decoder modules, the first latent space representation and one or more of: a target Quality of Service of the plurality of wireless devices; and a radio channel type of input, MIMO layers used by the wireless devices, BSR, an indication of whether a wireless device has a duplication of legs.

The motivation for these embodiments is that for the same control signal the table of, for example, a specific QoS may be different than the table of another QoS, therefore conditioning based on, for example, QoS may improve accuracy of the training.

In some examples, the training of the autoencoder may be initiated in response to a change in one of: channel condition, channel position, QoS of wireless devices, MIMO layer usage and carrier aggregation. For example, the network node may be configured to retrain the autoencoder when the channel condition, channel position, QoS of the wireless devices, MIMO layer using and/or carrier aggregation changes beyond the previous values used for training.

In some embodiments an error handling mechanism may be implemented. For example, errors resulting from in-accuracy or errors due resulting from reconstruction of the decoder modules at the wireless devices may occur.

In order to address these potential errors, a category of codes called error detection codes (EDC) or error correction codes (ECC) may be used. One type of EDC is a Cyclic Redundancy Checks (CRC).

In some examples, the network node may include an error code in each of the plurality of control signals input into the encoder module.

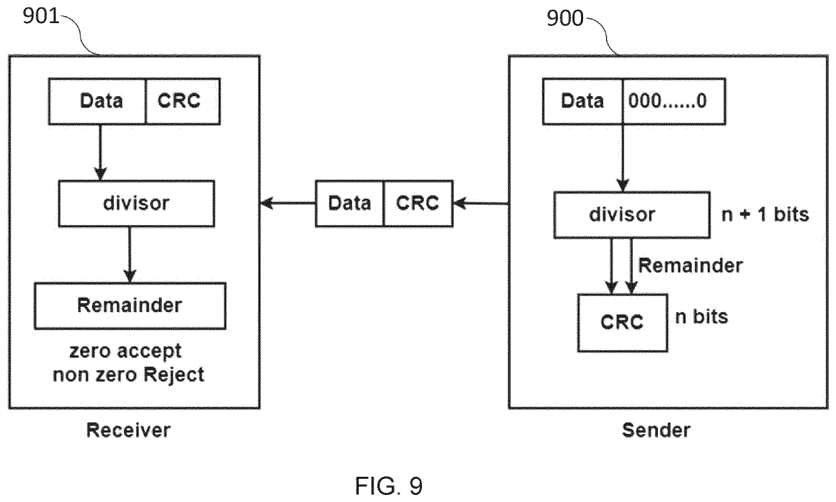

FIG. 9 illustrates an example of a CRC. CRC may be considered the most powerful method for Error-Detection and Correction. It will however, be appreciated that other methods for error detection and/or correction may be used.

To implement CRC the network node 900 may produce a kbit message, and the network node creates an n bit sequence called frame check sequence. The control signal to be encoded by the network node, including the n bit FCS, is precisely divisible by some fixed number (divisor, P).

Modulo 2 Arithmetic may be used in this binary addition with no carries, just like an XOR operation.

For example, an example control signal to be input into the autoencoder may comprise:

$$CP Signal ( DCI ) = 1010001101 ( 10 bits , k = 10 )$$

The divisor P=110101 (6=n+1 bits). The divisor may be exchanged beforehand with all wireless devices that have decoder modules.

FCS R=to be calculated 5 bits (n bits)

The message is generated through 2⁵: accommodating 1010001101000

The product is divided by P.

The remainder is inserted to 2⁵D to provide T=101000110101110 that is encoded and sent to the decoder module.

The decoder module in the wireless device 901 then decodes the received message and divides the result by the divisor P. Suppose that there are no errors, and the decoder module decoded T perfectly. The decoded control signal would be divisible by P with no remainders.

If the remainder at the output of each decoder module (of AE) is zero, then no error has occurred.

However, if the remainder of at a decoder module is non-zero, then an error has occurred.

Returning to FIG. 8, it will be appreciated that each wireless device may perform a cyclic redundancy check, CRC, on the first control signal.

Responsive to the CRC indicating that an error has occurred at the decoder module, the first wireless device may transmit, in step 815, a request to the network node to retrain the autoencoder.

The network node may then retrain the autoencoder and may send updated decoder modules to the plurality of wireless devices.

Alternatively, the responsive to the CRC indicating that an error has occurred at the decoder module, the first wireless devices may transmit a request to the network node to transmit the control signal information without encoding. This may guarantee successful reception of the control signal information at the first wireless device.

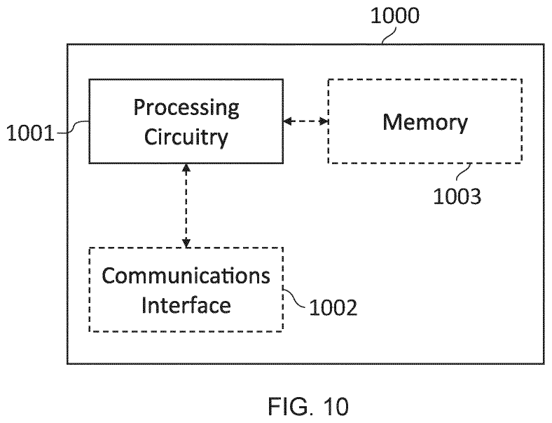

FIG. 10 illustrates a training apparatus 1000 comprising processing circuitry (or logic) 1001. The processing circuitry 1001 controls the operation of the training apparatus 1000 and can implement the method described herein in relation to a training apparatus 1000. The processing circuitry 1001 can comprise one or more processors, processing units, multi-core processors or modules that are configured or programmed to control the training apparatus 1000 in the manner described herein. In particular implementations, the processing circuitry 1001 can comprise a plurality of software and/or hardware modules that are each configured to perform, or are for performing, individual or multiple steps of the method described herein in relation to the training apparatus 1000.

Briefly, the processing circuitry 1001 of the training apparatus 1000 is configured to: encode a first set of training data using the encoder module to generate a first latent space representation, wherein the first set of training data comprises control signals associated with the plurality of wireless devices; use the plurality of decoder modules to decode the first latent space representation to generate a respective plurality of reconstructed control signals; and update the plurality of decoder modules based on the plurality of reconstructed control signals.

In some embodiments, the training apparatus 1000 may optionally comprise a communications interface 1002. The communications interface 1002 of the training apparatus 1000 can be for use in communicating with other nodes, such as other virtual nodes. For example, the communications interface 1002 of the training apparatus 1000 can be configured to transmit to and/or receive from other nodes requests, resources, information, data, signals, or similar. The processing circuitry 1001 of training apparatus 1000 may be configured to control the communications interface 1002 of the training apparatus 1000 to transmit to and/or receive from other nodes requests, resources, information, data, signals, or similar.

Optionally, the training apparatus 1000 may comprise a memory 1003. In some embodiments, the memory 1003 of the training apparatus 1000 can be configured to store program code that can be executed by the processing circuitry 1001 of the training apparatus 1000 to perform the method described herein in relation to the training apparatus 1000. Alternatively or in addition, the memory 1003 of the training apparatus 1000, can be configured to store any requests, resources, information, data, signals, or similar that are described herein. The processing circuitry 1001 of the training apparatus 1000 may be configured to control the memory 1003 of the training apparatus 1000 to store any requests, resources, information, data, signals, or similar that are described herein.

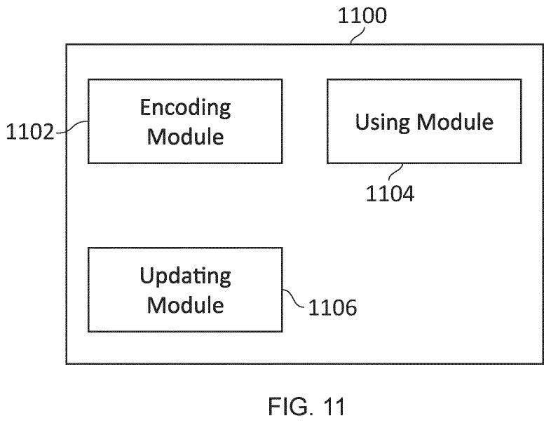

FIG. 11 is a block diagram illustrating a training apparatus 1100 according to some embodiments. The training apparatus 1100 is for training an autoencoder. The training apparatus 1100 comprises an encoding module 1102 configured to encode a first set of training data using the encoder module to generate a first latent space representation, wherein the first set of training data comprises control signals associated with the plurality of wireless devices. The training apparatus 1100 further comprises a using module 1104 configured to use the plurality of decoder modules to decode the first latent space representation to generate a respective plurality of reconstructed control signals. The training apparatus further comprises an updating module 1106 configured to update the plurality of decoder modules based on the plurality of reconstructed control signals.

The training apparatus 1100 may operate in the manner described herein in respect of a training apparatus.

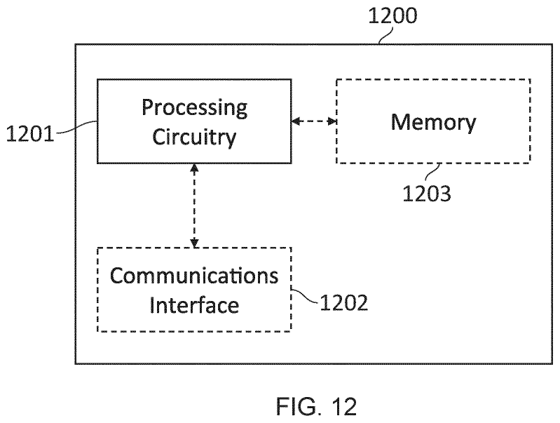

FIG. 12 illustrates a network node 1200 comprising processing circuitry (or logic) 1201.

The processing circuitry 1201 controls the operation of the network node 1200 and can implement the method described herein in relation to a network node 1200. The processing circuitry 1201 can comprise one or more processors, processing units, multi-core processors or modules that are configured or programmed to control the network node 1200 in the manner described herein. In particular implementations, the processing circuitry 1201 can comprise a plurality of software and/or hardware modules that are each configured to perform, or are for performing, individual or multiple steps of the method described herein in relation to the network node 1200.

Briefly, the processing circuitry 1201 of the network node 1200 is configured to: determine a plurality of control signals to transmit to a plurality of wireless devices; encode the plurality of control signals using an encoder module to generate a first latent space representation; and transmit the first latent space representation to the plurality of wireless devices.

In some embodiments, the network node 1200 may optionally comprise a communications interface 1202. The communications interface 1202 of the network node 1200 can be for use in communicating with other nodes, such as other virtual nodes. For example, the communications interface 1202 of the network node 1200 can be configured to transmit to and/or receive from other nodes requests, resources, information, data, signals, or similar. The processing circuitry 1201 of network node 1200 may be configured to control the communications interface 1202 of the network node 1200 to transmit to and/or receive from other nodes requests, resources, information, data, signals, or similar.

Optionally, the network node 1200 may comprise a memory 1203. In some embodiments, the memory 1203 of the network node 1200 can be configured to store program code that can be executed by the processing circuitry 1201 of the network node 1200 to perform the method described herein in relation to the network node 1200. Alternatively or in addition, the memory 1203 of the network node 1200, can be configured to store any requests, resources, information, data, signals, or similar that are described herein. The processing circuitry 1201 of the network node 1200 may be configured to control the memory 1203 of the network node 1200 to store any requests, resources, information, data, signals, or similar that are described herein.

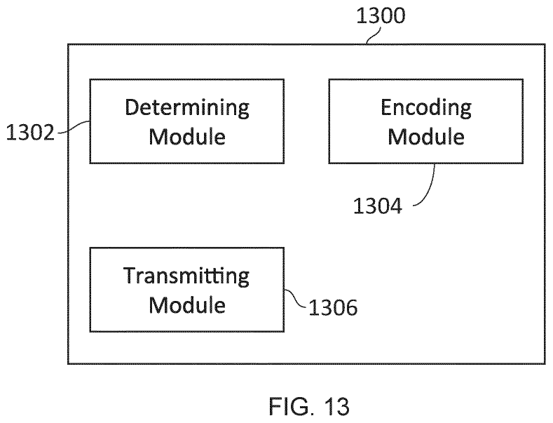

FIG. 13 is a block diagram illustrating a network node 1300 according to some embodiments. The network node 1300 comprises a determining module 1302 configured to determine a plurality of control signals to transmit to a plurality of wireless devices. The network node 1300 further comprises an encoding module 1304 configured to encode the plurality of control signals using an encoder module to generate a first latent space representation. The network node further comprises a transmitting module 1306 configured to transmit the first latent space representation to the plurality of wireless devices. The network node 1300 may operate in the manner described herein in respect of a network node.

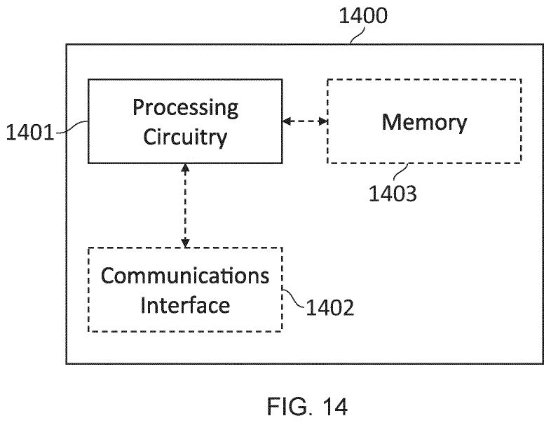

FIG. 14 illustrates a wireless device 1400 comprising processing circuitry (or logic) 1401. The processing circuitry 1401 controls the operation of the wireless device 1400 and can implement the method described herein in relation to a wireless device 1400. The processing circuitry 1401 can comprise one or more processors, processing units, multi-core processors or modules that are configured or programmed to control the wireless device 1400 in the manner described herein. In particular implementations, the processing circuitry 1401 can comprise a plurality of software and/or hardware modules that are each configured to perform, or are for performing, individual or multiple steps of the method described herein in relation to the wireless device 1400.

Briefly, the processing circuitry 1401 of the wireless device 1400 is configured to: receive a first latent space representation, wherein the first latent space representation comprises information derived from a plurality of control signals; and decode the first latent space representation using a decoder module to determine a first control signal.

In some embodiments, the wireless device 1400 may optionally comprise a communications interface 1402. The communications interface 1402 of the wireless device 1400 can be for use in communicating with other nodes, such as other virtual nodes. For example, the communications interface 1402 of the wireless device 1400 can be configured to transmit to and/or receive from other nodes requests, resources, information, data, signals, or similar. The processing circuitry 1401 of wireless device 1400 may be configured to control the communications interface 1402 of the wireless device 1400 to transmit to and/or receive from other nodes requests, resources, information, data, signals, or similar.

Optionally, the wireless device 1400 may comprise a memory 1403. In some embodiments, the memory 1403 of the wireless device 1400 can be configured to store program code that can be executed by the processing circuitry 1401 of the wireless device 1400 to perform the method described herein in relation to the wireless device 1400. Alternatively or in addition, the memory 1403 of the wireless device 1400, can be configured to store any requests, resources, information, data, signals, or similar that are described herein. The processing circuitry 1401 of the wireless device 1400 may be configured to control the memory 1403 of the wireless device 1400 to store any requests, resources, information, data, signals, or similar that are described herein.

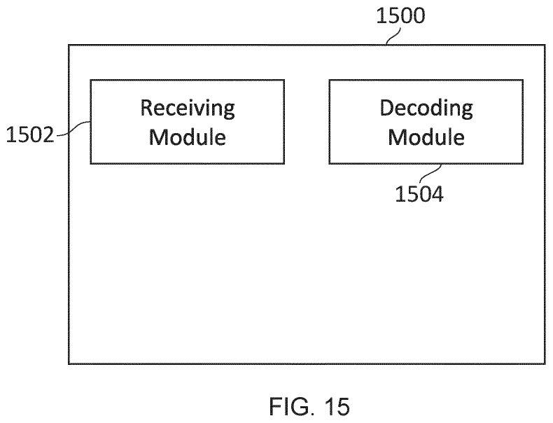

FIG. 15 is a block diagram illustrating a wireless device 1500 according to some embodiments. The wireless device 1500 comprises a receiving module 1502 configured to receive a first latent space representation, wherein the first latent space representation comprises information derived from a plurality of control signals. The wireless device 1500 further comprises a decoding module 1504 configured to decode the first latent space representation using a decoder module to determine a first control signal. The wireless device 1500 may operate in the manner described herein in respect of a wireless device.

There is also provided a computer program comprising instructions which, when executed by processing circuitry (such as, for example, the processing circuitry 1001 of the training apparatus 1000 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Embodiments described herein advantageously reduce the number of bits required to be sent for control messages, which can be frequent. For example, as determined above, about 3.3 kbits may have previously been required for 100 wireless devices to receive a single DCI scheduling occasion (~couple of msec) for a specific control message type, i.e., DCI_0_1. As the number of bits are reduced, there is less overhead. As less bits are required, there is also a reduction of interference. Furthermore, as less bits are transmitted the energy efficiency at the network node is improved as transmission of bits may require more energy consumption than inference of an autoencoder or performance of PCA.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method of training an autoencoder for use in transmitting control signals between a network node and a plurality of wireless devices, wherein the autoencoder comprises: an encoder module, and a respective plurality of decoder modules associated with the plurality of wireless devices, the method comprising:
encoding a first set of training data using the encoder module to generate a first latent space representation, wherein the first set of training data comprises control signals associated with the plurality of wireless devices;
using the plurality of decoder modules to decode the first latent space representation to generate a respective plurality of reconstructed control signals; and
updating the plurality of decoder modules based on the plurality of reconstructed control signals.

2. The method of claim 1, further comprising:
clustering an initial group of wireless devices based one or more criteria; and
selecting a cluster of wireless devices as the plurality of wireless devices, wherein
the one or more criteria comprise one or more of: similar Quality of Service, QoS, targets; similar radio channels; wireless devices associated with the same Multiple Input Multiple Output MIMO layers.

3. (canceled)

4. The method of claim 1, further comprising:
clustering the plurality of wireless devices to determine subgroups of wireless devices; and
for each subgroup of wireless devices: training a new encoder module and retraining the decoder modules associated with the subgroup of wireless devices.

5. The method claim 4, wherein the step of clustering of the plurality of wireless devices comprises:
for each decoder module, determining which of a plurality of latent space channels affect the output of the decoder module; and
grouping wireless devices associated with decoder modules that are affected by the same latent space channels.

6. (canceled)

7. The method of claim 1, wherein the step of updating comprises:
for a first decoder module in the plurality of decoder modules, wherein the first decoder module is associated with a first wireless device:
determining a first loss function based on the output of the first decoder module and a control signal in the first set of training data associated with the first wireless device.

8. The method of claim 7, wherein the step of updating further comprises:
updating the first decoder module using the first loss function.

9. The method of claim 7, wherein the step of updating further comprises:
determining a generalised loss function based on the first loss function and previous loss functions calculated for other decoder modules in the plurality of decoder modules at a previous time; and
updating the first decoder module using the generalised loss function.

10-11. (canceled)

12. The method of claim 1, further comprising:
during updating of a first decoder module, updating first layers of the encoder module, wherein the first layers of the encoder module are related to the first decoder module.

13. (canceled)

14. The method of claim 1, wherein
the step of using the plurality of decoder modules to decode the first latent space representation comprises: inputting, into the plurality of decoder modules, the first latent space representation and one or more of: a target Quality of Service of the plurality of wireless devices; and a radio channel type of input, MIMO layers used by the wireless devices, Buffer Status Report, BSR, an indication of whether a wireless device has a duplication of legs, and
wherein the control signals comprises one or more of: Modulation and Coding Scheme, MCS, selection signals, Channel state information-Reference Signal, CSI-RS, configuration signals, Downlink Control Indication, DCI, format signals and Configured Grant Configuration signals.

15-16. (canceled)

17. A method, in a network node, of transmitting control signals to a plurality of wireless devices, the method comprising:
determining a plurality of control signals to transmit to a plurality of wireless devices;
encoding the plurality of control signals using an encoder module to generate a first latent space representation; and
transmitting the first latent space representation to the plurality of wireless devices.

18. (canceled)

19. The method of claim 17, further comprising:
including an error code in the plurality of control signals input into the encoder module; and
receiving, responsive to an error occurring in a decoder module at a wireless device, a request to retrain the autoencoder that the decoder module is comprised within.

20. (canceled)

21. The method of claim 17, further comprising:
clustering an initial group of wireless devices based on one or more criteria; and
selecting a cluster of wireless devices as the plurality of wireless devices.

22-24. (canceled)

25. The method of claim 17, wherein
the step of encoding comprises utilizing principal component analysis to determine one or more principal components, and
the first latent space representation comprises: the determined one or more principal components, a mean value of the features in the plurality of control signals column wise, and transformation.

26-27. (canceled)

28. A method, in a wireless device, of receiving control signals from a network node, the method comprising:
receiving a first latent space representation, wherein the first latent space representation comprises information derived from a plurality of control signals; and
decoding the first latent space representation using a decoder module to determine a first control signal.

29. (canceled)

30. The method of claim 28, further comprising:
performing a cyclic redundancy check (CRC) on the first control signal; and
(a) responsive to the CRC indicating that an error has occurred at the decoder module, transmitting a request to the network node to retrain autoencoder response to an error occurring in a decoder at a wireless device, or
(b) responsive to the CRC indicating that an error has occurred at the decoder module, transmitting a request to the network node to transmit the control signal information without encoding.

31-34. (canceled)

35. The method of claim 28, wherein
the first latent space representation comprises; one or more principal components, a mean value, and a transformation, and
the step of decoding comprises: calculating a dot product of the transformation and a transpose of the principal components; and adding the mean value.

36-38. (canceled)

39. A training apparatus for training an autoencoder for use in transmitting control signals between a network node and a plurality of wireless devices, wherein the autoencoder comprises: an encoder module, and a respective plurality of decoder modules associated with the plurality of wireless devices, the training apparatus comprising processing circuitry configured to cause the training apparatus to perform the method of claim 1.

40. (canceled)

41. A network node for transmitting control signals to a plurality of wireless devices, the network node comprising processing circuitry configured to cause the network node to perform the method of claim 17.

42. (canceled)

43. A wireless device for receiving control signals from a network node, the wireless device comprising processing circuitry configured to cause the wireless device to perform the method of claim 28.

44-46. (canceled)
